(19) United States
(12) Patent Application Publication
(10) Pub. No.: US 2016/0113186 A1
(43) Pub. Date: Apr. 28, 2016

(54) Material Handling Device

(71) Applicant: Ronald MCAFEE, Barrie (CA)

(72) Inventors: Ronald MCAFEE, Barrie (CA); Vaclav MORKUS, Barrie (CA)

(73) Assignee: Ronald MCAFEE, Barrie (CA)

(21) Appl. No.: 14/920,601

(22) Filed: Oct. 22, 2015

Related U.S. Application Data
(60) Provisional application No. 62/067,079, filed on Oct. 22, 2014.

(51) Int. Cl. A01B 1/02

(52) U.S. Cl. CPC A01B 1/02; A01B 1/026

(57) ABSTRACT

A material handling device to be used on non-horizontal platforms such as roofs, hills, construction sites, and other sloped surfaces. The device is comprised of a large blade for collecting debris or other materials such as shingles. The blade connects to a first handle that hangs forwardly over the opening of the blade. This handle is meant to assist lifting by placing the handle over the center of gravity of the load in the shovel. The blade is also attached to an angle adjustment pivot assembly. The pivot assembly is attached to an elongated handle. The adjustment mechanism adjusts the angle between the blade and the shaft. At the first end of the shaft is an anchor assembly, comprising an anchoring pin. The anchoring pin can be hammered into the surface to secure the shovel from falling or slipping. The shaft is then connected at its second end to a second anchor. The second anchor comprises a second anchoring pin to be used in the same manner as the first, an end handle for manoeuvring the shovel, as well as a remote latch mechanism to control the angle between the blade and the shaft.

### CROSS-REFERENCE TO RELATED APPLICATIONS

This application claims priority from U.S. Provisional Application No. 62/067,079, filed on Oct. 22, 2014 and titled “Material Handling Device”, the entire contents of which is incorporated herein by reference.

### FIELD OF THE INVENTION

The present invention relates to a material handling device, commonly referred to as a shovel.

### DESCRIPTION OF THE PRIOR ART

Shovels are used in many applications for moving material between locations or accumulating and moving waste for disposal. Shovels consist of a blade, usually with upturned edges to contain material of varying sizes, with the blade coupled to handle to facilitate manipulation and movement.

The handle is disposed at a convenient angle to the blade to allow the user to move the material. Because the user needs to get hold of the handle when the blade is in the material, the handle is usually arranged at an angle to the blade so the end of the handle is raised from the surface. The shovel is dimensioned to maximise the load that may be carried at any one time, depending on the material with which it is intended to be used and the environment in which it is used. An issue arises when the shovel is used on an inclined or sloped surface such as a roof. It is desirable to minimise the number of movements and number of trips for the relocation of the material. However, this suggests a large blade area where a larger amount of waste material may be accumulated. A larger blade area suggests an increase in the length of the handle to provide leverage for lifting. Moreover, the inclination of the handle relative to the blade means that one or other will project upwardly when the shovel is laid on the roof, causing a potential trip hazard and limited contact with the surface.

U.S. Pat. No. 6,412,841 provides a multiuse cleanup tool system construction wherein it can be utilized as a dustpan or a shovel. However, such a tool still poses limitations as it is not effective on sloped surfaces such as roofs and risks slipping or falling off the surface creating a potential safety risk.

To attempt to enhance the ability to work on sloped surfaces, U.S. Pat. No. 7,025,397 shows a scoop for use on non-horizontal work surfaces. The patent shows the use of two baseplates connected to meet at a 120-170 degree angle with further plates attached to close blade in the to form a pan. The side of the scoop can have handles for lifting. However, this design also lacks a conventional handle to allow for ease in manoeuvrability and relies on friction between the scoop and surface to retain the scoop on the sloped surface when not attended by a user.

It is desirable to obviate or mitigate at least one of the above-mentioned drawbacks.

### SUMMARY OF THE INVENTION

Below are example embodiments of the material handling device and example aspects thereof. Other embodiments and aspects are provided in the detailed description and the figures.

Accordingly, the present invention provides a shovel comprising a blade, a handle connected to the blade by a pivot assembly. The pivot assembly includes a latch to control relative movement between the blade and the handle. The latch is movable between a locked position in which relative movement is inhibited, and a released position in which such movement is permitted. An anchor is mounted on the shovel and may be deployed to engage a surface upon which the shovel is placed.

Preferably, the anchor is a pin mounted on the handle and moveable between a stored position and the deployed position. As a further preference a pair of anchors is provided at spaced locations on the handle.

It is also preferred that the latch is operated remotely from a distal end of the handle.

The blade can have various configurations, based on the application. It can consist of a singular piece of curved material or a single plate coupled with a plurality of plates to form walls around the single piece. The shovel can be formed from either a metal, metal alloys, or from plastics. The blade can also include a variety of different ribbing.

In a preferred embodiment, when the shovel is placed in a manner such that the anchoring pins are perpendicular to the surface, the anchoring pins can be driven into the surface. The number of anchoring pins can range from a single pin to a plurality of pins housed within anchor assemblies spaced along the elongated handle respectively. A hammer or similar device can be used to strike the pins and drive them into the surface. Once the anchoring pins are driven into the surface they are able to retain the shovel and inhibit it from sliding and falling. When it is desired for the shovel to be moved the pins can be pulled out from the surface and the shovel can be relocated as desired.

In a further aspect, the present invention also provides a shovel having a blade, a first handle secured to the blade at a rear portion thereof and projecting rearward from the blade, and a second handle secured to said blade and projecting forwardly from the rear edge of the blade.

When relocating the shovel the second handle hanging over the blade can be used to assist in lifting the load. When the shovel is heavy it can be strenuous to lift and carry the shovel from a point away from the center of mass. Placing the handle in a manner that projects over the shovel blade places the handle closer to the center of mass and makes the process of relocating the shovel more ergonomic.

### BRIEF DESCRIPTION OF THE DRAWINGS

An embodiment of the invention will now be described by way of example only with reference to the accompanying drawings in which

FIG. 1 is a perspective view of a roof with a shovel placed on the roof

FIG. 2 is a top perspective view of the shovel of FIG. 1

FIG. 3 is a view similar to FIG. 2 on an enlarged scale

FIG. 4a is an enlarged view of a portion of FIG. 2 in a first condition

FIG. 4b is a view similar to FIG. 4a in a second condition

FIG. 5 is a front perspective view of the shovel in the alternate configuration of FIG. 4b

FIG. 6 is a cross sectional view across the line 6-6;

FIG. 7a is a perspective view of the shovel in one configuration

FIG. 7b is a perspective view of the shovel in an alternate configuration to FIG. 6b

FIG. 8 is a view similar to FIG. 1 showing the shovel used in a different configuration.

The features of the invention will become more apparent in the following detailed description in which reference is made to the appended drawings.

### DETAILED DESCRIPTION OF THE INVENTION

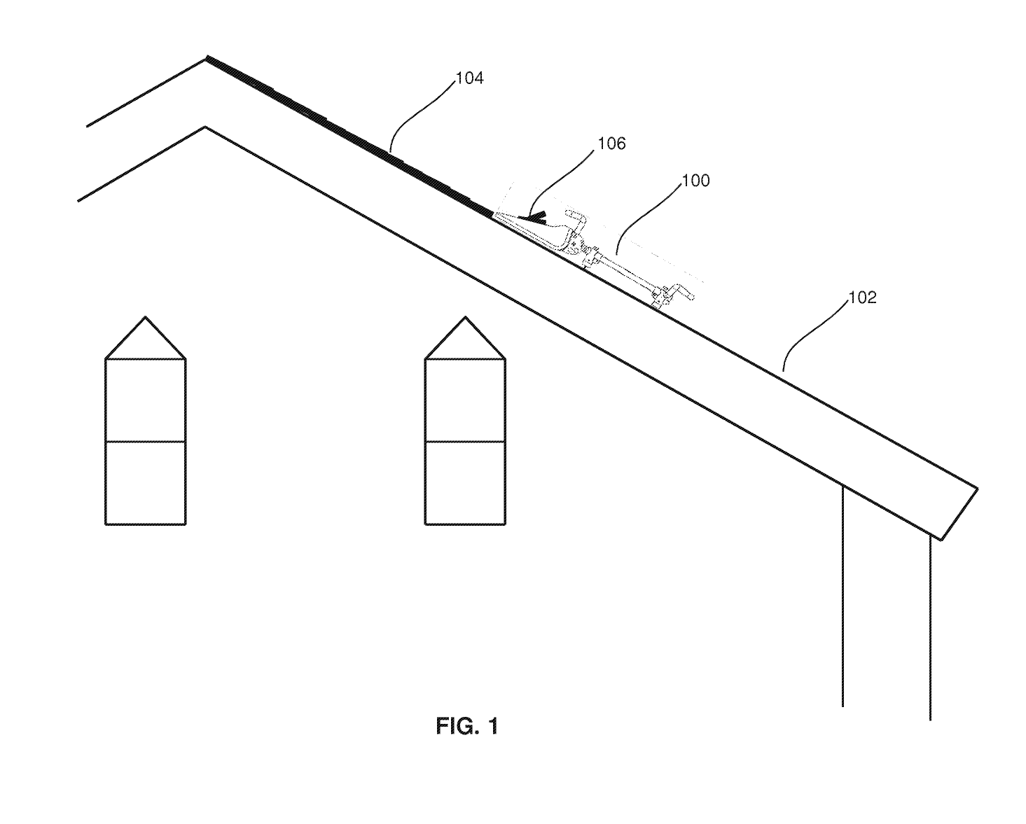

Referring to FIG. 1, a roof 102 is clad with shingles 104 that periodically require removal. To facilitate removal of debris such as removed shingles 106, a shovel 100 is used to collect debris and transfer it to a disposal site.

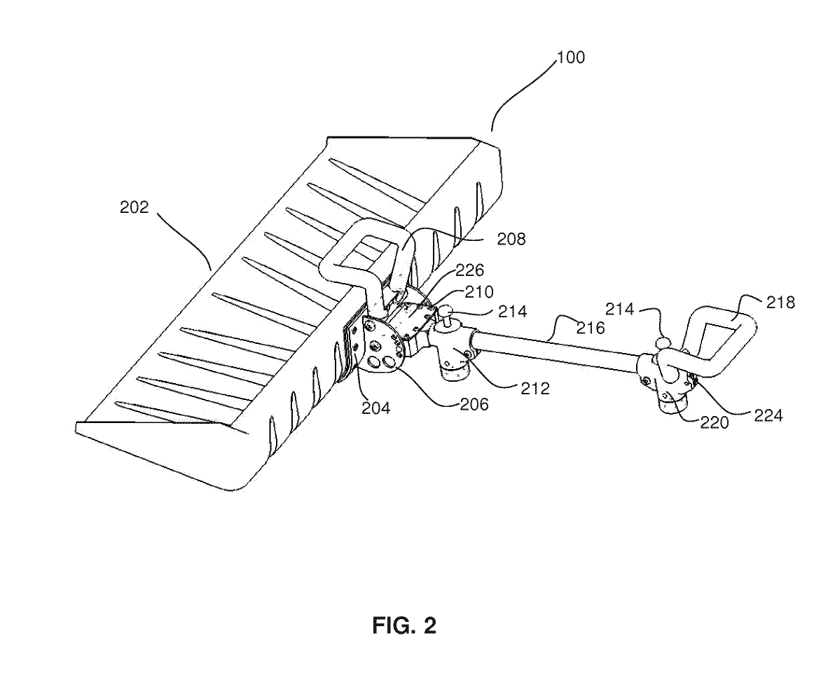

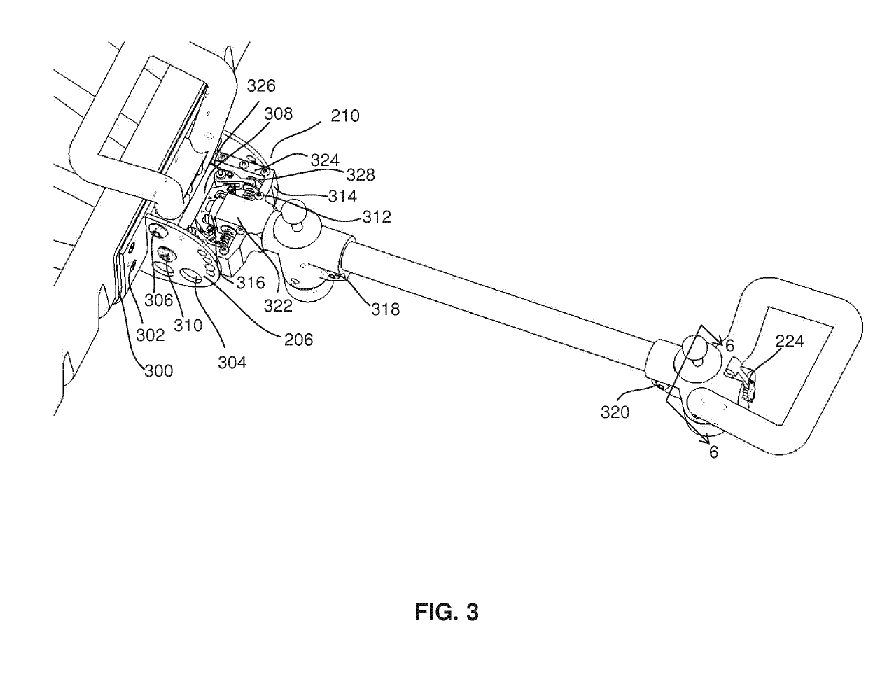

Referring to FIGS. 2 and 3, a shovel 100 comprises a blade 202 and a handle 216. The blade 202 and handle 216 are interconnected by an attachment assembly 205. The assembly 205 is mounted on the blade 202 by a bracket 204 using fasteners 302. In between the bracket and the blade there is a reinforcement plate 300.

A first handle 208 is attached to the bracket 204 using fasteners 306. The handle 208 includes a pair of upstanding arms L-shaped 209 and a bar 211 extending between the arms 209. The arms 209 project forwardly over the blade 202 to locate the bar 211 forwardly of the attachment assembly 206.

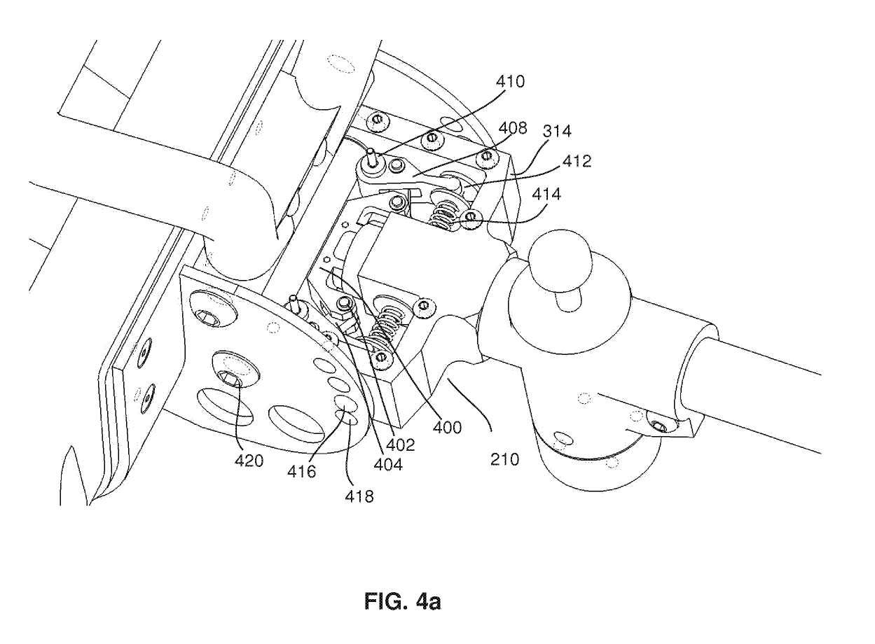

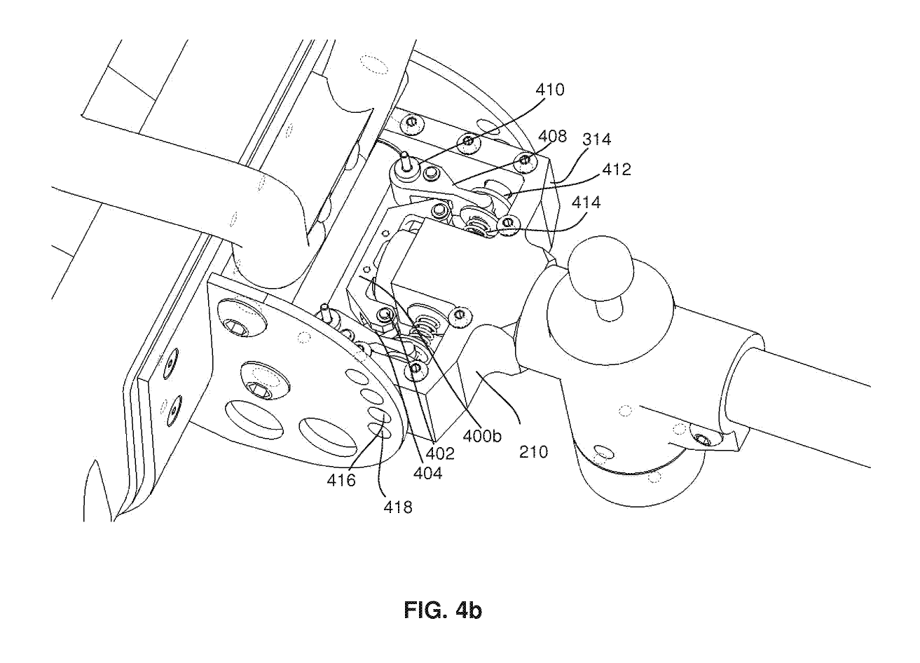

The attachment assembly 206 also includes a pivot assembly 210, best seen in FIG. 3. The pivot assembly includes a pair of spaced plates 206 that are secured to the bracket 204. The plates 206 include a plurality of bored out holes 304 and a plurality of adjustment holes 418 as shown in FIG. 4. A shaft 308 is coupled to the back of the pivot assembly 210 and is fastened to the attachment assembly 206 using fasteners 310 that pass through apertures 420 (FIG. 4a) in respective ones of the spaced plates 206.

As shown in FIGS. 4a and 4b the adjustment holes 418 on plates 206 are spaced along an arc centered on the aperture 420. The pivot assembly 210 further includes a clevis 314 with a pair of arms 324 extending from the clevis base 322. The arms 324 are spaced apart to be received between the plates 206 and each has a bore 326 to receive shaft 308. The shaft 308 thus defines an axis of rotation of the clevis 314 relative to the blade 202. Each of the arms 324 has a through hole 328 spaced from the bore 326 along the arc of the holes 418. The through-hole 328 receives a locking pin 416 that can slide relative to the arm 324 to engage one of the holes 418. The pins 416 are biased by springs 414 that act between heads of the pins 416 and a central boss 316 projecting from the clevis base 322. Movement of the pins 416 is controlled by a release mechanism located at the clevis.

The release mechanism includes a latch base 400 slidably mounted in the boss 316 of the clevis 314. The base 400 is coupled to a plurality of latch levers 404 via links 406. The latch levers 404 are pivotally mounted on the clevis 314 on an axial bearing 410 and the opposite end engage a circumferential recess 408 formed on the heads of the pins 416. The pivot assembly 210 is enclosed by a top plate 226 fastened to the clevis 314 using the fasteners 312.

The boss 316 of the clevis 314 includes a rear facing cylindrical recess to receive a shaft 217 of the handle 216. The shaft 217 terminates in a grip 218 allowing the user to firmly grasp the handle 216 to maneuver or manipulate the device.

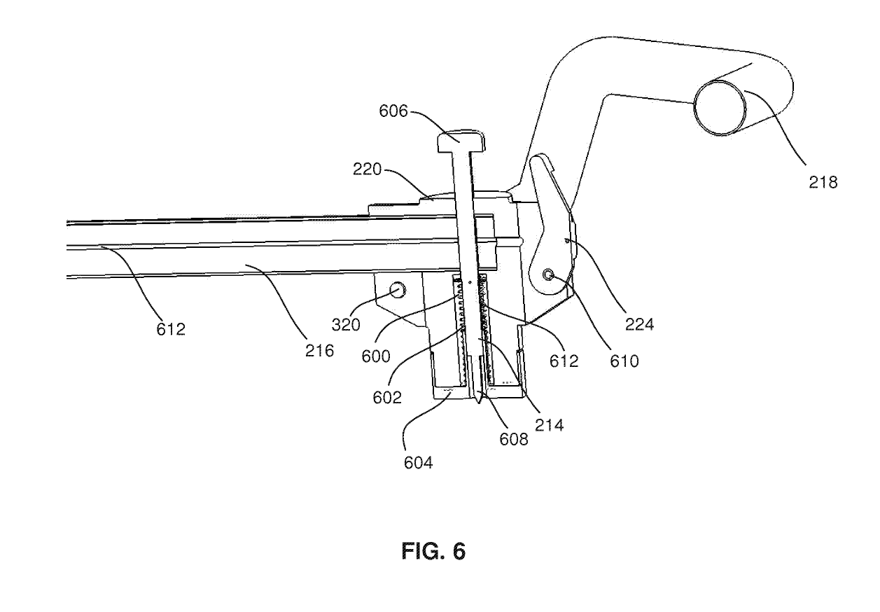

A trigger 224 is located within the grip 218 and includes a lever 219 pivotally connected to the grip 218 by a pin 610 (FIG. 6).The lever is connected to a cable 612 that extends through the handle 216 and is connected to the latch base 400.

The shaft 217 of the elongated handle 216 carries a pair of anchor assemblies, 212, 220 at spaced locations. The first anchor assembly 212 is secured adjacent the inner end of the shaft 217 using fastener 318 and the second anchor 220 secured using fastener 320.

Referring again to FIG. 6, each of the anchor assemblies 212, 220 includes an anchor pin 214 slide-able in a boss 600. The elongated handle has a transverse pinhole 612, dimensioned to receive an anchoring pin 214. The anchors 212, 220 include a compression spring 602 within the boss 600 that acts between an end plate 604 and the pin 214 to bias the pin to a retracted position in which the lower end of the pin 214 is located within the boss 600.

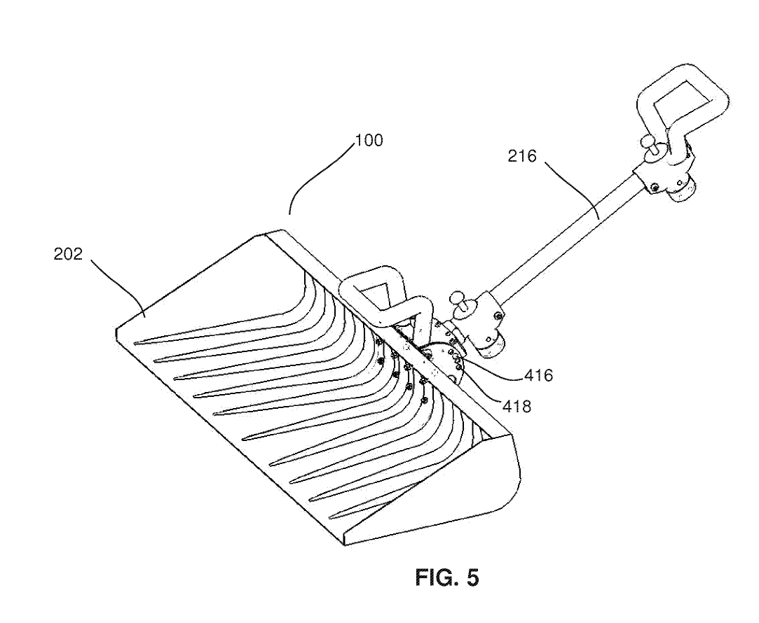

FIGS. 4a and 4b show alternate configurations of the pivot assembly 210. In FIG. 4a the pivot assembly is locked with the pin 416 engaged in one of the holes 418. When the angle between the blade 202 and elongated handle 216 needs to be adjusted, the trigger 224 is actuated by operating the lever 219. The lever 219 then pulls the cable 612 causing the latch base 400 to recede, thereby causing the pivot assembly to adopt the configuration as denoted by FIG. 4b. The receding of the latch base 400 causes the link bar 406 to pull the latch levers 404 and pivot them about the bearing 410. As the latch lever 404 rotates about the axial bearing 410 it acts through the head against the bias of the spring 414 to retract the pin 416 from engagement with adjustment hole 418. The user can then adjust the angle of the handle 216 by pivoting about the shaft 308. When the angle is adjusted as desired the user releases the remote latch 224 causing the latch base 400 to return to its original position under the bias of the springs 414, reengaging the latch lock 416 and locking it into the desired adjustment hole 418. In this manner, alternative configurations can be obtained for the shovel 100, as illustrated in FIG. 5, which shows the shovel 100 after the adjustment of the angle between the blade 202 and the elongated handle 216.

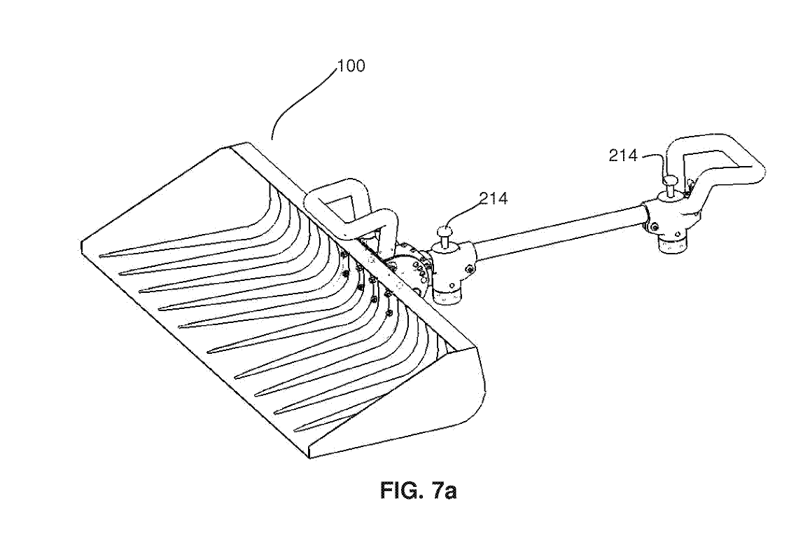

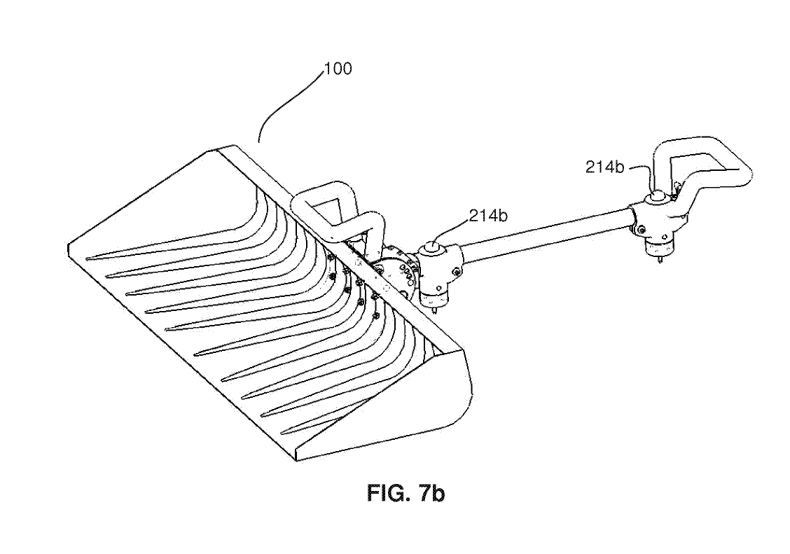

Referring to FIGS. 6, 7a and 7b, when the shovel 100 is desired to be secured on a sloped surface, such as when it is being loaded with debris, the orientation of the handle is adjusted so that it is generally parallel with the base of the blade 202. In this configuration, the the nails 214 are perpendicular or near perpendicular to the surface 102. The nail head 606 of the anchor pins 214 can be driven downwardly by a tool such as a hammer. The anchor pins 214 are driven out of the boss 600 and in to the underlying surface, such as the roof 102, as seen in FIG. 1.

When it is desired to remove or relocate the tool, the anchoring nail 214 can be pulled out of the surface using a tool such as a hammer.

One exemplary application of the tool is shown in FIG. 1. The shovel 100 is used on the sloped surface of the roof 102. The anchor pins 214 are driven into the surface of the roof 102, securing the shovel 100 from slipping or sliding. When the shingles 104 of the roof 102 are removed they can be gathered in the blade 202 of the shovel 100. The shovel 100 can hold debris 106, the debris comprising removed shingles along with other waste from working on the roof 102.

When it is desired for the shovel to be relocated the anchor pins 214 can be pulled out of engagement with the roof 102 and the angle between the blade 202 and elongated handle 216 can be adjusted using the pivot assembly 210 after pulling the trigger 224. Then, when the shovel is in the desired configuration the shovel can be lifted at the first handle 208 as shown in FIG. 2. The handle 208 hangs forward over the blade 202 allowing the user to lift the tool from closer to the center of the mass after the debris has been collected in the blade 202. The ability to lift from the center of mass offers a more efficient means to manoeuvre the shovel 100.

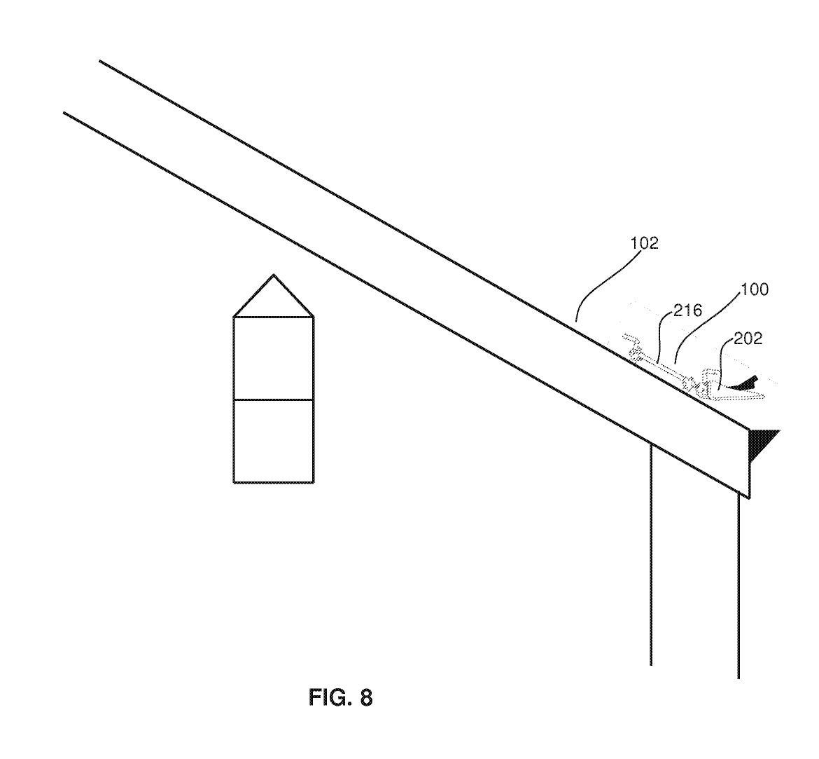

The adjustability of the handle 216 relative to the blade 202 facilitates the use of the shovel 100 in different orientations on the roof 102, as shown in FIG. 8. In this orientation, the blade 202 faces down the roof and is adjusted relative to the handle 216 to minimise the angle between them. The blade thus projects upwardly from the roof to provide a more horizontal surface than the roof itself. This permits debris to be cleared from the lower portions of the roof and from the eaves troughs and placed on the shovel in a stable manner. The handle is secured to the roof by the anchor pins 214 that prevent sliding down the roof and tipping of the shovel when loaded. The shovel may be released by withdrawing the anchor pins 214 and moved as previously described.

The shovel 100 is shown in the exemplary embodiments as having two anchors to house the anchor pin 214, however; it can be appreciated that only one anchor may be used, or several anchors can be utilized along the length of the elongated handle 216.

It can be appreciated that though the specification provided details the use of the shovel on a sloped surface, the shovel can still be utilized any surface in the same method of a traditional shovel or shovel.

The particular design of the blade, elongated handle, the pivot assembly, and anchors are selected to satisfy structural conditions due to static and dynamic loads in repeated use within working environments.

Below are general example embodiments and example aspects of the material handling device.

In a general example embodiment, a shovel is provided which includes: a blade, a handle pivotally connected to the blade by a pivot assembly at one end to permit pivotal movement of the handle relative to the blade, and at least one anchor assembly mounted on the handle; the anchor assembly including a fastener operable to secure the shovel on a surface.

In an example aspect of the shovel, the pivot assembly includes a lock assembly, the lock assembly operable between a locked position, in which relative movement between the blade and handle is inhibited, and a released position in which relative movement between the blade and handle is permitted. In another aspect, a pair of plates are attached to the blade and spaced along an axis perpendicular to the longitudinal axis of the handle, the plates each having a corresponding aperture; and a rod member extends between the plates and is fastened at the apertures; and a housing is attached to the plates and the rod member, wherein the housing is pivotable about the rod member, and the housing has a bore to receive the handle. In another aspect, the housing houses the lock assembly. In another aspect, the plates each have a plurality of corresponding adjustment holes spaced along an arc centered on the aperture, and the lock assembly comprises locking pins operable by the movement of a release mechanism to engage and disengage with the adjustment holes to respectively inhibit and permit relative movement between the housing and the plates. In another aspect, the locking pins are biased to be engaged into the adjustment holes. In another aspect, the handle supports a trigger for the lock assembly, the trigger being operable to operate the release mechanism to further operate the lock assembly between said locked and released positions. In another aspect, the trigger includes a pivotable lever, the lever connected to a cable that extends through a longitudinal bore in the handle and connects to the release mechanism such that pivoting the lever disengages the locking pins from the engagement holes. In another aspect, the handle of the shovel includes an elongate shaft and a grip, wherein one end of the shaft is received into the bore of the housing and the grip is situated at the opposing end of the shaft. In another aspect, the trigger is proximal to the grip. In another aspect, trigger is incorporated in the grip. In another aspect, the shovel has a plurality of anchor assemblies provided at spaced locations on the shaft. In another aspect, a first anchor assembly is attached to the shaft proximate to the blade. In another aspect, the shovel further includes a second anchor assembly attached to the shaft proximate to the grip. In another aspect, the fastener of each of the first and second anchor assemblies is at least one pin. In another aspect, each of the anchor assemblies includes at least one boss in which the at least one pin is slideable, and the shaft has a transverse pinhole dimensioned and positioned to receive each of the at least one anchoring pin. In another aspect, the anchor assembly further includes a biasing element within the at least one boss to act between an end plate and the pin to bias the pin to a retracted position in which the lower end of the pin is located within the at least one boss. In another aspect, the second anchor assembly is incorporated in the grip. In another aspect, the shovel has an additional handle attached to the shovel proximate to the blade, and the additional handle projects above and over the blade.

In another general example embodiment, a shovel is provided which includes: a blade, a first handle connected to the blade, and a second handle attached to the shovel proximate the blade wherein the second handle projects above and over the blade.

In an example aspect of the shovel, the first handle projects away from the blade. In another aspect, the second handle projects in the opposite direction of the first blade. In another aspect, the first handle is pivotally connected to the blade by a pivot assembly at one end to permit pivotal movement of the first handle relative to the blade.

In another general example embodiment, a shovel is provided which includes: a shovel comprising: a blade, a handle pivotally connected to the blade by a pivot assembly at one end to permit pivotal movement of the handle relative to the blade; wherein the pivot assembly includes a lock assembly such that the lock assembly is operable between a locked position, in which relative movement between the blade and handle is inhibited, and a released position in which relative movement between the blade and handle is permitted; and a trigger for the lock assembly attached to the handle distal from the lock assembly, wherein the trigger includes an actuator and a link extending from the actuator to a release mechanism such that moving the actuator operates the lock assembly between the locked and unlocked position.

In an example aspect of the shovel, the actuator is a pivotable lever. In another aspect, the link is a cable. In another aspect, the lever is connected to the cable and the cable extends through a longitudinal bore in the handle, and the cable connects to a release mechanism such that pivoting the lever operates the lock assembly between the locked and unlocked position.

What is claimed is:

1. A shovel comprising:
a blade;
a handle pivotally connected to the blade by a pivot assembly at one end to permit pivotal movement of the handle relative to the blade; and
at least one anchor assembly mounted on the handle, the anchor assembly including a fastener operable to secure the shovel on a surface.

2. The shovel of claim 1 wherein the pivot assembly includes a lock assembly, the lock assembly operable between a locked position, in which relative movement between the blade and handle is inhibited, and a released position in which relative movement between the blade and handle is permitted.

3. The shovel of claim 2 wherein the pivot assembly further includes:
a pair of plates attached to the blade and spaced along an axis perpendicular to the longitudinal axis of the handle, the plates each having a corresponding aperture;
a rod member extending between the plates and fastened at the apertures;
a housing attached to the plates and the rod member, wherein the housing is pivotable about the rod member, and the housing having a bore to receive the handle.

4. The shovel of claim 3 wherein the housing houses the lock assembly.

5. The shovel of claim 4 wherein the plates each have a plurality of corresponding adjustment holes spaced along an arc centered on the aperture, and the lock assembly comprises locking pins operable by the movement of a release mechanism to engage and disengage with the adjustment holes to respectively inhibit and permit relative movement between the housing and the plates.

6. The shovel of claim 5 wherein the locking pins are biased to be engaged into the adjustment holes.

7. The shovel of claim 6 wherein the handle supports a trigger for the lock assembly, the trigger being operable to operate the release mechanism to further operate the lock assembly between said locked and released positions.

8. The shovel of claim 7 wherein the trigger includes a pivotable lever, the lever connected to a cable that extends through a longitudinal bore in the handle and connects to the release mechanism such that pivoting the lever disengages the locking pins from the engagement holes.

9. The shovel of claim 8 wherein the handle of the shovel includes an elongate shaft and a grip, wherein one end of the shaft is received into the bore of the housing and the grip is situated at the opposing end of the shaft.

10. The shovel of claim 9 wherein the trigger is proximal to the grip.

11. The shovel of claim 10 wherein the trigger is incorporated in the grip.

12. The shovel of the claim 10 wherein the shovel has a plurality of anchor assemblies provided at spaced locations on the shaft.

13. The shovel of claim 12 wherein a first anchor assembly is attached to the shaft proximate to the blade.

14. The shovel of claim 13 wherein the shovel further includes a second anchor assembly attached to the shaft proximate to the grip.

15. The shovel of claim 14 wherein the fastener of each of the first and second anchor assemblies is at least one pin.

16. The shovel of claim 15 wherein each of the anchor assemblies includes at least one boss in which the at least one pin is slideable, and the shaft has a transverse pinhole dimensioned and positioned to receive the at least one anchoring pin.

17. The shovel of claim 16 wherein the anchor assembly further includes a biasing element within the at least one boss to act between an end plate and the pin to bias the pin to a retracted position in which the lower end of the pin is located within the at least one boss.

18. The shovel of claim 15 wherein the second anchor assembly is incorporated in the grip.

19. The shovel of claim 1 wherein the shovel has an additional handle attached to the shovel proximate to the blade, the additional handle projecting above and over the blade.

20. A shovel comprising:
a blade;
a first handle connected to the blade; and
a second handle attached to the shovel proximate the blade wherein the second handle projects above and over the blade.

21. The shovel of claim 20 wherein the first handle projects away from the blade.

22. The shovel of claim 21 wherein the second handle projects in the opposite direction of the first blade.

23. The shovel of claim 20 wherein the first handle is pivotally connected to the blade by a pivot assembly at one end to permit pivotal movement of the first handle relative to the blade.

24. A shovel comprising:
a blade;
a handle pivotally connected to the blade by a pivot assembly at one end to permit pivotal movement of the handle relative to the blade, wherein the pivot assembly includes a lock assembly, the lock assembly operable between a locked position, in which relative movement between the blade and handle is inhibited, and a released position in which relative movement between the blade and handle is permitted; and
a trigger for the lock assembly attached to the handle distal from the lock assembly, wherein the trigger includes an actuator and a link extending from the actuator to a release mechanism such that moving the actuator operates the lock assembly between the locked and unlocked position.

25. The shovel of claim 24 wherein the actuator is a pivotable lever.

26. The shovel of claim 25 wherein the link is a cable.

27. The shovel of claim 22 wherein the lever is connected to the cable and the cable extends through a longitudinal bore in the handle, and the cable connects to a release mechanism such that pivoting the lever operates the lock assembly between the locked and unlocked position.
